(19) United States
(12) Patent Application Publication
(10) Pub. No.: US 2020/0088468 A1
(43) Pub. Date: Mar. 19, 2020

(54) Roasting Furnace for Producing Industrial Catalyst

(71) Applicant: ZHONGRONG TECHNOLOGY CO., LTD., Tangshan, HB (CN)

(72) Inventors: Qiuyuan LI, Tangshan (CN); Shumei DAI, Tangshan (CN)

(73) Assignee: ZHONGRONG TECHNOLOGY CO., LTD., Tangshan, HB (CN)

(21) Appl. No.: 15/743,276

(22) PCT Filed: Feb. 9, 2017
(86) PCT No.: PCT/CN2017/073141

§ 371 Date: Jan. 9, 2018

(30) Foreign Application Priority Data
Oct. 19, 2016 (CN) 201610909934.6

(51) Int. Cl. F27B 9/04; F27B 17/00; F27D 7/04; F27D 5/00

(52) U.S. Cl. CPC F27B 9/045; F27B 17/0083; F27M 2002/04; F27D 5/00; F27D 2007/045; F27D 7/04

(57) ABSTRACT

A roasting furnace for the production of industrial catalysts, provided with a ventilation system comprising a fresh air duct system and a circulating air duct system, wherein the fresh air duct system includes a high pressure blower, a fresh air inlet pipe and a loading frame. The fresh air-and-circulating air mixed roasting system allows the fresh air and circulating air to be fully mixed and dispersed to provide even heating. The catalyst product obtained after roasting has stable quality, good catalytic activity, and high strength.

### TECHNICAL FIELD

The present invention relates to a roasting furnace for the production of industrial catalysts.

### BACKGROUND

With the development of industrial catalysis technology, the catalytic reaction in the industrial production has become more and more demanding on the performance of the catalyst. In order to meet this need, researchers are also increasingly complicating the catalyst development. Catalyst components and its preparation processes are increasingly critical. As an important part of catalyst preparation, roasting process puts more and more requirements on roasting technology and equipment.

Additionally, in the production of industrial catalysts, some catalysts may contain volatile substances during the process of roasting. If these substances cannot be volatilized in time, the phenomena of temperature runaway or even flash burn may occur during the process of roasting. As a result, the chemical composition of the catalyst may be changed or the physical properties may be damaged, such as reduced strength, shape deformation, pore collapse, or specific surface area change. Consequently, the catalytic performance is greatly damaged, causing huge economic losses.

### SUMMARY

In order to solve the above problems, the present invention provides a roasting furnace for producing an industrial catalyst provided with a fresh and circulating air mixed roasting system. With the special internal structure of the roasting furnace, the fresh air and the circulating air are fully mixed and dispersed. The semi-finished catalyst product placed in the roasting furnace is able to fully and uniformly contact with the heated air, to achieve the effect of uniform heating. In a second aspect, the present invention provides a method for precisely controlling the roasting temperature of catalyst, by which the problems such as catalyst stably heating, volatile components volatilizing immediately during roasting is solved to form a good catalytic reaction center.

To achieve the above object, the present invention adopts the following technical solutions.

A roasting furnace for the production of industrial catalysts, comprising a furnace body, a thermal insulation layer, a heating element, a loading frame and a tray, a high-pressure blower and a circulating fan, characterized in that the furnace body is provided with a ventilation system comprising a fresh air duct system and a circulating air duct system. The fresh air duct system includes a high pressure blower, a fresh air inlet pipe and a loading frame. The fresh air inlet pipe and the loading frame are connected to each other and the fresh air flows into the loading frame through the fresh air inlet pipe. The loading frame is composed of connected horizontal and vertical pipes to form an integral fixed hollow structure. The loading frame is divided into two parts from the middle thereof, forming a front part and a rear part, or a left part and a right part. The horizontal pipes are arranged in layers in the furnace body and the tray loaded with catalyst is placed on the horizontal pipes of the loading frame to form a loading layer. Both inner sides and the top side of the furnace body are provided with a circulating air duct from top to bottom. A circulating air duct is also formed between an inner casing of the furnace body and the loading frame. The top of the furnace body is provided with a circulating air inlet at the center thereof. The bottom of the both inner sides of the furnace body is provided with a main air outlet. Both sides of the furnace body are provided with a grille air outlet respectively. Thereby the circulating air duct system is formed. The top of the furnace body is provided with an air vent. The circulation fan is arranged within the furnace body at top thereof. The high-pressure blower is arranged on the furnace body, and a fresh air inlet is arranged on the furnace body; both inner sides of the furnace body are provided with the heating elements respectively.

Preferably, a central air duct is provided between the two parts of the loading frame.

Preferably, the bottom of the tray is supported by the horizontal pipes that also act as a fresh air distributor, and the horizontal pipes are formed with a plurality of holes as fresh air outlets according to needs.

Preferably, the fresh air outlets are oriented downwards and staggered with a diameter of 0.5 to 5 mm.

Preferably, the tray loaded with catalyst in each layer is a single flat-shaped piece and a plurality of trays are provided, each movably connected to the loading frame.

Preferably, both sides of each loading layer corresponding to a grille air outlet respectively to form multiple grille air outlets to ensure uniformity of the temperature inside the furnace.

Preferably, the high-pressure blower is arranged outside the furnace body and connected with the loading frame through the fresh air inlet pipe. The high-pressure blower is provided with a variable-frequency governor for precisely controlling the amount of air supply.

Preferably, the furnace body is provided with one to three internal circulating fans therein in form of mixed-flow/centrifugal fan for agitating the airflow inside the furnace.

Preferably, the furnace body is a run-through structure with a door installed at one or both of the front and rear ends thereof.

As compared with the prior art, the present invention establishes a fresh and circulating air mixed roasting system according to the characteristics of the catalyst. With the special internal structure of the roasting furnace, the fresh air and the circulating air are fully mixed and dispersed. The semi-finished catalyst product placed in the roasting furnace is able to fully and uniformly contact with the heated air. The loading frame is used as the fresh air duct, and holes are formed in each layer of the horizontal pipes of the loading frame so that they act as fresh air distributor. The fresh air is quickly and uniformly mixed with the circulating air and the mixed air flow over the surface of the catalyst to ensure that the catalyst is evenly heated and the volatile components are discharged timely and thoroughly.

The catalyst product obtained after roasting has stable quality, good catalytic activity, and high strength.

### BRIEF DESCRIPTION OF THE DRAWINGS

FIGS. 1-2 illustrate a cross-sectional view of the roasting furnace according to the present invention.

Reference signs: 1—furnace body; 2—main air outlet; 3—inner casing; 4—grille air outlet; 5—circulating air duct; 6—thermal insulation layer; 7—furnace door mechanism; 8—loading frame; 9—fresh air inlet pipe; 10—high-pressure blower; 11—fresh air inlet; 12—fresh air outlet; 13—heating element; 14—circulating fan; 15—circulating air inlet; 16—air vent.

### DETAILED DESCRIPTION OF THE INVENTION

The present invention will be further described with reference to the accompanying drawings.

The following examples are for the purpose of illustrating the invention only, and the structure, size, arrangement, and shape of the various components may vary. On the basis of the technical solutions of the present invention, improvements and equivalent transformations of individual components according to the principle of the present invention should not be excluded from the scope of the present invention.

A fresh and circulating air mixed roasting furnace for the production of industrial catalysts comprises a furnace body 1, a thermal insulation layer 6, a heating element 13, a loading frame 8 and a tray, a circulating air duct system, a fresh air duct system, a high-pressure blower 10, a circulating fan 14 and etc.

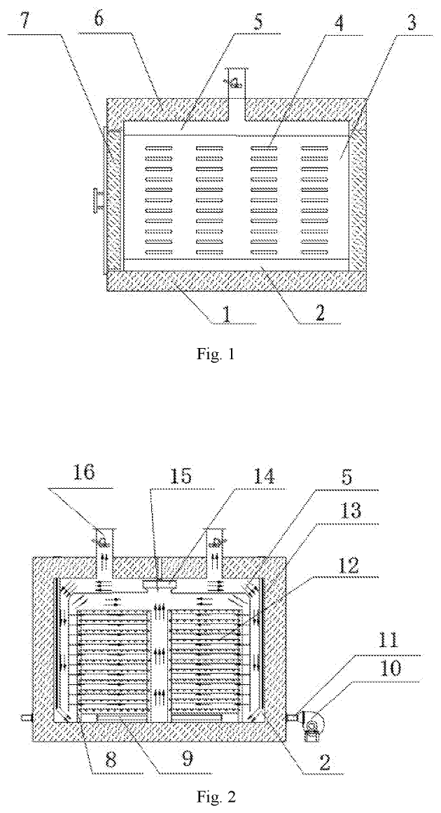

The detailed structure is shown in FIGS. 1-2. The furnace body 1 is welded from section steel and high-quality plate steel to effectively improve deformation resistance performance of the furnace. A refractory fiber thermal insulation layer 6 featuring high temperature resistance, low thermal conductivity and simple maintenance is arranged between the inner casing and outer casing of the furnace body. The inner casing is made of heat-resistant steel plate (316L, etc.), which has excellent high-temperature anti-oxidation performance and can be used reliably for a long time. The bottom of the inner casing is provided with high strength heat-resistant load-bearing bricks that can maintain high mechanical strength under the high temperature and maintain the stability at working condition. The furnace body 1 is a run-through structure with a door installed at one or both of the front and rear ends thereof. The door is opened and closed manually by a hand wheel, whereby a furnace door mechanism 7 is formed.

The ventilation system of the furnace body 1 comprises a fresh air duct system and a circulating air duct system. The specific structure of the circulating air duct system is as follows: both sides and top in the furnace body are provided with a circulating air duct 5 from top to bottom, and a circulating fan 14 is provided within the furnace body at top thereof. According to an embodiment, inside the furnace body there is provided with one to three internal circulating fans 14 in form of mixed-flow/centrifugal fan for agitating airflow inside the furnace so as to increase temperature uniformity in the furnace. The top of the furnace body is provided with a circulating air inlet 15, which is formed at the center of the furnace body. The bottom of the both sides in the furnace body is provided with a main air outlet 2 and the both sides of the furnace body are respectively provided with a grille air outlet 4. As shown in FIG. 2, a fresh air inlet 11 is provided at the bottom/sides outside the furnace body. The circulating fan 14, circulating air duct 5, circulating air inlet 15, main air outlet 2, grille air outlet 4, and fresh air outlet 12 form the circulating air duct system. One to six air vents 16 equipped with regulating valve are provided at the top of the furnace body in order to discharge the exhaust gas.

The fresh air duct system comprises a high-pressure blower, a fresh air inlet pipe 9 and a loading frame 8, which is connected to the fresh air inlet pipe 9. The fresh air flows into the loading frame 8 through the fresh air inlet pipe 9 from the high-pressure blower. The high-pressure blower is installed outside the furnace body, connected with the loading frame 8, and is provided with a variable-frequency governor for precisely controlling the amount of air supply. According to an embodiment, one to four sets of high-pressure blower are provided. The fresh air is supplied to the loading frame 8 through the fresh air inlet pipe 9 from the high-pressure blowers that regulate the amount of air supply by the variable-frequency governor. In order to keep the air clean, an air filter is fitted at the fresh air inlet of the high pressure blower.

According to an embodiment, the loading frame 8 is a fixed structure made of high temperature-resistant stainless steel profiles and pipes (316L, etc). It is formed of horizontal and vertical pipes that are welded together. The horizontal pipes are formed in layers according to need and each layer is placed with catalyst-loaded trays thereon. These catalyst-loaded trays placed on the horizontal pipes of the loading frame form a loading layer. Both sides of each loading layer correspond to a grille air outlet respectively to form multiple grille air outlets to ensure uniform temperature inside the furnace. The catalyst-loaded tray in each layer is a single flat-shaped piece. A plurality of trays are provided, each movably connected to the loading frame so that they can be removed according to needs.

Both sides of each loading layer correspond to a grille air outlet 4 respectively to form multiple grille air outlets to ensure uniform temperature inside the furnace. The loading frame 8 as a whole is a hollow structure that plays a role of fresh air duct. In a direction vertical to the furnace door, the loading frame 8 is divided into two parts from the middle thereof, including a front part and a rear part, or a left part and a right part, with a central air duct serving as a mixed air converging duct formed between the two parts. The bottom of the tray is supported by the horizontal pipes made of circular tube or square tube. The horizontal pipes are formed with a plurality of holes as fresh air outlets. The fresh air outlets are oriented downwards and staggered to blow air in form of distributor, and have a diameter of 0.5 to 5 mm. The fresh air is quickly and uniformly mixed with the circulating air and the mixed air flow over the surface of the catalyst to ensure that the catalyst is evenly heated so as to meet the technological requirements of catalyst roasting and blowing.

The roasting furnace uses electric heating and heating elements 13 are provided on both inner sides of the furnace body. According to an embodiment, the heating elements are electric heating fin tubes. The electric heating fin tubes are in form of radiant tubes that are produced by forming cages of Fe—Cr—Al heating materials and arranging the cages within the closed heat-resistant steel tubes, to prevent the heating elements from corrosion by the redox atmosphere and prolong lifespan of the heating elements. The electric heating fin tubes evenly arranged on both inner sides of the furnace body uniformly radiate the heat to the catalyst to meet the roasting requirements.

A thermal insulation layer 6 is adhered between the inner casing and outer casing of the furnace body except for the bottom thereof. The thermal insulation layer 6 is formed of high-quality refractory fiber featuring high temperature resistance, low thermal conductivity and simple maintenance. A circulating air duct 5 is formed between the inner casing of the furnace body and the loading frame.

The working process of the present invention will be described hereunder.

An amount of catalyst is manually loaded onto each layer of trays of the loading frame, then the furnace door is closed and the temperature is increased within the furnace body, meanwhile all the circulating fans are activated, and the blower is activated to a certain degree according to the needs. As shown in FIG. 2, following the directions indicated by the arrows, the circulating air is drawn up through the circulating air inlet disposed inside the furnace body at the top thereof and then blew out through the grille air outlets formed on both sides and the main air outlets formed at the bottom of the furnace body, during which it flows through each layer of the catalyst on the loading frame and mixed with fresh air blew downwards from each layer of horizontal pipes, then the mixed air is sent upwards back to the top circulating air duct through the central air duct of the loading frame. The fresh air sent from the high-pressure blower flows into the loading frame through the fresh air inlet pipe and delivered downwards through the air outlets formed on each layer of the horizontal pipes of the loading frame, then mixed with the circulating air and enters the circulating air duct. A small portion of the mixed circulating air is discharged through the air vents. The remaining mixed circulating air is heated by the heating elements arranged on both inner sides of the furnace body and reenters the inner casing to provide heat to the catalyst being roasted. The roasting temperature is slowly increased to 300 to 800° C., then the blower is turned off, the catalyst is kept for 1 to 10 hours, then cooled down and taken out. The above described process can be repeated.

The temperature control system of the present invention features multistage programming that provides function control in different time periods or temperature sections, so as to meet different technological requirements.

While the present invention has been described in detail by the general description and the specific embodiments thereof, it will be obvious to those skilled in the art that the present invention can be modified or improved. Therefore, these modifications or improvements made without departing from the spirit of the present invention all fall within the scope of the present invention.

1. A roasting furnace for the production of industrial catalysts, comprising a furnace body, a thermal insulation layer, a heating element, a loading frame and a tray, a high-pressure blower and a circulating fan, characterized in that the furnace body is provided with a ventilation system comprising a fresh air duct system and a circulating air duct system, the fresh air duct system includes a high pressure blower, a fresh air inlet pipe and a loading frame, the fresh air inlet pipe and the loading frame are connected to each other and the fresh air flows into the loading frame through the fresh air inlet pipe, the loading frame is composed of connected horizontal and vertical pipes to form an integral fixed hollow structure, the loading frame is divided into two parts from the middle thereof, forming a front part and a rear part, or a left part and a right part, the horizontal pipes are arranged in layers in the furnace body and the tray loaded with catalyst is placed on the horizontal pipes of the loading frame to form a loading layer, both inner sides and the top side of the furnace body are provided with a circulating air duct from top to bottom, a circulating air duct is also formed between an inner casing of the furnace body and the loading frame, the top of the furnace body is provided with a circulating air inlet at the center thereof, the bottom of the both inner sides of the furnace body is provided with a main air outlet, both sides of the furnace body are provided with a grille air outlet respectively, thereby the circulating air duct system is formed, the top of the furnace body is provided with an air vent, the circulation fan is arranged within the furnace body at top thereof, the high-pressure blower is arranged on the furnace body, and a fresh air inlet is arranged on the furnace body; both inner sides of the furnace body are provided with the heating elements respectively.

2. The roasting furnace for the production of industrial catalysts according to claim 1, characterized in that a central air duct is provided between the two parts of the loading frame.

3. The roasting furnace for the production of industrial catalysts according to claim 1, characterized in that the bottom of the tray is supported by the horizontal pipes that also act as a fresh air distributor, and the horizontal pipes are formed with a plurality of holes as fresh air outlets according to needs.

4. The roasting furnace for the production of industrial catalysts according to claim 1 or 3, characterized in that the fresh air outlets are oriented downwards and staggered with a diameter of 0.5 to 5 mm.

5. The roasting furnace for the production of industrial catalysts according to claim 1, characterized in that the tray loaded with catalyst in each layer is a single flat-shaped piece and a plurality of trays are provided, each movably connected to the loading frame.

6. The roasting furnace for the production of industrial catalysts according to claim 1, characterized in that both sides of each loading layer corresponding to a grille air outlet respectively to form multiple grille air outlets to ensure uniformity of the temperature inside the furnace.

7. The roasting furnace for the production of industrial catalysts according to claim 1, characterized in that the high-pressure blower is arranged outside the furnace body and connected with the loading frame through the fresh air inlet pipe, the high-pressure blower is provided with a variable-frequency governor for precisely controlling the amount of air supply.

8. The roasting furnace for the production of industrial catalysts according to claim 1, characterized in that the furnace body is provided with one to three internal circulating fans therein in form of mixed-flow/centrifugal fan for agitating the airflow inside the furnace.

9. The roasting furnace for the production of industrial catalysts according to claim 1, characterized in that the furnace body is a run-through structure with a door installed at one or both of the front and rear ends thereof.
